(19) United States
(12) Patent Application Publication
(10) Pub. No.: US 2005/0276562 A1
(43) Pub. Date: Dec. 15, 2005

(54) Fiber optic closure with integral cable management and sealing features

(76) Inventors: Jennifer A. Battey, Euless, TX (US); Guy Castonguay, Ft. Worth, TX (US); Jason B. Reagan, The Colony, TX (US)

Correspondence Address: CORNING CABLE SYSTEMS LLC, P O BOX 489, HICKORY, NC, 28603, US

(21) Appl. No.: 10/864,627

(22) Filed: Jun. 9, 2004

(51) Int. Cl. G02B 6/00

(52) U.S. Cl. 385/135; 385/134

(57) ABSTRACT

A fiber optic interconnection closure includes a base and a cover, wherein an outer periphery of the base defines a surface for routing a fiber optic distribution cable into a cable entry location defined by the base. Alternatively, a fiber optic interconnection closure includes a base, a cover and at least one connector port located in an exterior wall of the base for receiving a fiber optic drop cable. An outer periphery of the base defines a surface for routing at least the distribution cable into a cable entry location defined by the base. In another embodiment, a fiber optic communications network includes a fiber optic distribution cable, at least one fiber optic drop cable, and an interconnection closure including a base and a cover. An outer periphery of the base defines a surface for routing at least the distribution cable into a cable entry location defined by the base.

### BACKGROUND OF THE INVENTION

1. Field of the Invention

The present invention relates generally to a closure for interconnecting optical fibers, and more specifically, to a fiber optic closure with integral cable management and sealing features.

2. Description of the Related Art

Optical fiber cable is used for a variety of applications including voice communications, data transmission and the like. As a result of the increase in demand, fiber optic networks typically include an ever-increasing number of interconnection points in which one or more optical fibers of a distribution cable are interconnected with optical fibers of one or more drop cables. These interconnection points provide a convenient location for branching fiber optic drop cables to subscribers and may be used to supply “fiber-to-the-premises” (FTTP), “fiber-to-the-home” (FTTH) and “fiber-to-the-business” (FTTB), referred to generically as “FTTx”. Based on the increase in the number of interconnection points, and based on the locations of these points within a network (neighborhoods, etc), low volume, aesthetically pleasing closures are needed for protecting, handling, connecting and managing the optical fibers and fiber optic distribution and drop cables at the interconnection points. The closures should provide protection of the interconnection point as well as the accessed optical fibers and fiber optic cables from environmental influences, such as water intrusion, for example from wind-driven rain, and mechanical influences, such as stress.

With regard to aerial splice closures, there are several features that are typical in existing strand-mounted closures that the present invention improves. First, aerial splice closures typically require mid-span access to the distribution cable and most current strand-mounted closures are designed with two cable seals (one on each end of the closure) for the entrance and exit of distribution cable. Typically, separate seals are also provided for the entrance of the drop cables. By having multiple seals on the same closure, and by having the closure mounted along the strand as opposed to hanging below it, the difficulty of providing protection against water intrusion is increased. Second, the number of components needed for the multiple seals increases the complexity of the closure, increases the volume of the closure and increases the labor and time required to install the closure. Third, in addition to having multiple seals for the various cables, conventional splice closures typically use a molded or pre-formed gasket to seal the perimeter of the closure against water intrusion, which significantly increases the cost of the closure. Lastly, conventional closures do not provide integral cable management, but often require external cable routing guides that further increase the cost and complexity of the network and decrease the aesthetic benefit obtained from a slim profile, small volume closure.

To overcome these and other disadvantages, what is desired is a fiber optic closure having integral cable management and sealing features. What is also desired is a closure having a structure that allows the closure to hang below an aerial strand in such a way that a complex and costly seals are not necessary to prevent intrusion of wind driven rain into the closure. To further simplify the design of conventional closures, the improved closure should have a gasket-less seal around its periphery and have a cable routing contour that provides a natural drip loop for all cables routed into and out of the closure. By designing the closure in this way, it is not necessary to provide complex and costly cable seals for all cables entering and exiting the closure. To further improve upon current closure designs, and based on the recent emergence of “FTTx” networks, it is further desirable to provide a closure that not only includes all of the advantages described above, but also includes quick-connect drop cable ports that permit less experienced and less skilled technicians to perform optical connections and reconfigurations in the field a convenient mid-span access locations.

### BRIEF SUMMARY OF THE INVENTION

To achieve the foregoing and other objects, and in accordance with the purpose of the present invention as embodied and broadly described herein, the present invention provides various embodiments of fiber optic interconnection closures having integral cable management and sealing features. In one embodiment, the present invention provides a fiber optic interconnection closure comprising a base and a cover, wherein an outer periphery of the base defines a surface for routing a fiber optic distribution cable into a cable entry location defined by the base. In alternative embodiments, the interconnection closure may further comprise one or more of a funnel-shaped cable guiding feature, one or more cable routing tabs, one or more cable retention clips, one or more fiber routing guides, one or more fiber routing spools, a splice holder, or a grounding strip.

In another embodiment, the present invention provides a fiber optic interconnection closure comprising a base, a cover and at least one connector port located in an exterior wall of the base, wherein an outer periphery of the base defines a surface for routing a fiber optic distribution cable into a cable entry location defined by the base. In alternative embodiments, the interconnection closure may further comprise a funnel-shaped cable guiding feature, one or more fiber routing guides within the interior of the closure, one or more fiber routing spools, or a grounding strip on the back side of the base for grounding a conductive strength member of the distribution cable.

In yet another embodiment, the present invention provides a fiber optic communications network having a fiber optic distribution cable comprising a plurality of optical fibers and at least one mid-span access location along the length of the distribution cable for accessing and terminating preselected ones of the plurality of optical fibers, one or more fiber optic drop cables having one or more optical fibers optically connected to the terminated optical fibers of the distribution cable, and an interconnection closure comprising a base and a cover, wherein an outer periphery of the base defines a surface for routing the fiber optic distribution cable into a cable entry location defined by the base.

### BRIEF DESCRIPTION OF THE DRAWINGS

These and other features, aspects and advantages of the present invention are better understood when the following detailed description of the invention is read with reference to the accompanying drawings, wherein:

FIG. 1 is a front perspective view of an interconnection closure shown with the cover removed, wherein a base of the closure defines cable management and sealing features in accordance with an exemplary embodiment of the present invention;

FIG. 2 is a cross sectional view of a portion of the interconnection closure of FIG. 1 shown with the cover secured to the base and illustrating a sealing feature between the cover and the base;

FIG. 3 is a top plan view of the base of the interconnection closure of FIG. 1 illustrating a distribution cable routed into, within and out of the closure;

FIG. 4 is a top plan view of the base of the interconnection closure of FIG. 1 illustrating two fiber optic drop cables routed within and out of the interconnection closure;

FIG. 5 is a bottom plan view of the back side of the base of the interconnection closure of FIG. 1 illustrating the optical transmission component of a distribution cable routed into and out of the closure and the conductive strength member of the messenger component of the distribution cable affixed to the closure;

FIG. 6 is a front perspective view of an interconnection closure shown with the cover removed and having a plurality of connector ports, wherein a base of the closure defines cable management and sealing features in accordance with yet another exemplary embodiment of the present invention;

FIG. 7 is a top plan view of the base of the interconnection closure of FIG. 6 illustrating a distribution cable routed into, within and out of the interconnection closure; and

FIG. 8 is a top plan view of the base of the interconnection closure of FIG. 6 illustrating a plurality of pigtails routed within the closure to their respective connector ports and a typical drop cable attached to one of the pigtails at the connector port and routed out of the closure.

### DETAILED DESCRIPTION OF THE INVENTION

The present invention will now be described more fully hereinafter with reference to the accompanying drawings in which preferred embodiments of the invention are shown. This invention may, however, be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings.

The present invention provides various embodiments of interconnection closures for connecting preselected optical fibers of a distribution cable to one or more optical fibers of one or more drop cables. In the exemplary embodiments shown and described throughout the specification, the interconnection closure is an aerial closure that is supported by and hangs below the distribution cable or an existing strand in a communications network. However, in alternative network deployments, the interconnection closure may also be pole-mounted, housed within a pedestal or housed within a vault. It is envisioned that features may be added to the back of the closure to allow for mounting to a pole or to the internal structure of a pedestal. In all of the various embodiments, the closure consists of a cover and a base that are secured together using one or more fasteners, such as screws. The base and cover are preferably made of a lightweight yet rigid material, such as formed aluminum or molded UV resistant plastic. Although not shown, the cover may be tethered to the base to prevent separation. The closure is mounted to the aerial strand and allows mid-span access to preselected, terminated optical fibers of the distribution cable and “express” (i.e., un-terminated) optical fibers of the distribution cable, as well as the optical fibers of the drop cables. The various embodiments of the present invention may be deployed in a “fiber-to-the-premises” (FTTP) communication network, or in any fiber optic network in which it is desired to access and interconnect optical fibers of a distribution cable with optical fibers of a secondary, branch or drop cable in any manner now known or hereafter devised.

Throughout the specification, the term “distribution cable” is intended to include all types of fiber optic cables comprising a plurality of optical fibers within a cable jacket including, but not limited to, loose tube, monotube, central tube, tight buffered, ribbon, flat dielectric drop and the like. In the exemplary embodiments shown and described herein, the distribution cable is a tubeless figure-eight distribution cable or a standard single tube (SST) figure-eight distribution cable available from Corning Cable Systems of Hickory, N.C. The figure-eight cable comprises an optical transmission component, a strength or “messenger” component, and a cable jacket. In this design, the optical transmission component and the messenger component are separated from each other via the cable jacket, resulting in a figure-eight cross sectional configuration in which the messenger component may be separated from the optical transmission component without compromising the cable jacket surrounding the optical transmission component. In one embodiment, the messenger component comprises a conductive (e.g., metallic) strength member that may be either solid or made up of a plurality of strands wrapped in a helical fashion. In an alternative embodiment, the distribution cable is dielectric and the messenger component comprises a glass-reinforced plastic (GRP). The optical transmission component of the distribution cable comprises one or more optical waveguides, preferably up to about thirty-six, and more preferably between about twelve and about twenty-four, either disposed within a central buffer tube (monotube) or disposed within the cable jacket (tubeless). The distribution cable may also comprise additional strength members that provide tensile strength and resistance to cable shrinkage. It is understood that other cable types may be used in conjunction with the present invention. The distribution cable is preferably designed to provide stable performance over a wide range of temperatures and to be compatible with any telecommunications grade optical fiber. As used herein, the term “optical fiber” is intended to include all types of single mode and multi-mode light waveguides, including one or more bare optical fibers, coated optical fibers, loose-tube optical fibers, tight-buffered optical fibers, ribbonized optical fibers or any other expedient for transmitting light signals.

In all embodiments shown, the interconnection closure is breathable and does not comprise a sealing gasket disposed around the periphery of the closure between the cover and base. The closure may comprise one or more vents used to reduce condensation within the closure as required for free breathing aerial closures. The cable seal area is protected from water intrusion, and in particular wind-driven rain, by being recessed within the upper portion of the closure and shielded by an exterior wall of the base, thus providing a baffle effect from the wind and thereby allowing the cable seals to meet less stringent environmental requirements. By hanging the closure below the strand and by the manner in which the cables are routed into and out of the closure, natural drip loops are provided to prevent water from flowing along the cables to the cable seal area. The interconnection closure has a slim profile, small volume and low build cost due its reduced part count. In addition, because the closure design has only one protected cable seal area, a single, less robust cable seal is sufficient for all cables, despite the direction from which the cables are routed into the closure.

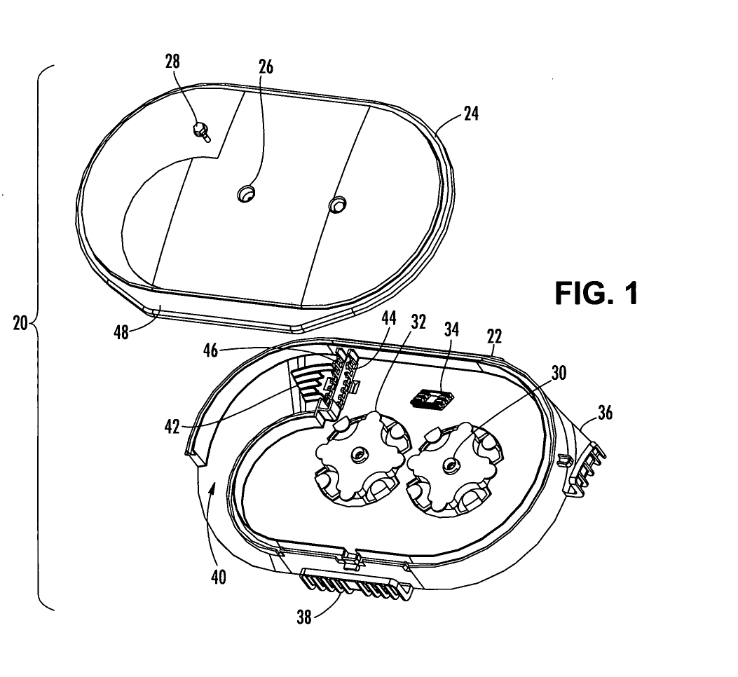

Referring now to FIG. 1, the interconnection closure 20 comprises a base 22 and a cover 24, each made of a lightweight, yet rigid material. Stiffening ribs (not shown) may be used to strengthen both the base 22 and the cover 24. Both the base 22 and the cover 24 define fastener recesses 26 for receiving captive screws 28 or like fasteners used to secure the base 22 and cover 24 together in the closed configuration. The screws 28 are also used to secure posts 30 within the interior cavity of the closure 20, and the posts 30 are in turn used to secure one or more fiber routing spools 32. In the embodiment shown, two routing spools 32 are used to manage and store optical fiber slack by wrapping the optical fibers around the spools 32, for example in a figure-eight pattern, as will be described. Having the ability to wrap the optical fibers in a figure-eight pattern allows any desired routing direction for entry into a splice tray or splice holder 34, or exit direction out of the closure 20. The routing spools 32 also allow the optical fibers of a distribution cable and one or more drop cables to be routed into and out of the closure 20 without violating the minimum bend radius of the fibers, while storing as much slack as needed. The routing spools 32 define a plurality of retention tabs and grooves for retaining the optical fibers of the distribution cable and the drop cables. Each routing spool 32 preferably has a diameter of about 3 inches in order to maintain the minimum bend radius of about 1.5 inches of the optical fibers. While fusion splicing is the preferred method of splicing the optical fibers within the closure 20, it is understood that any known method of splicing optical fibers may be practiced, such as mechanical splicing or connection via fiber optic connectors. Splices are secured within individual splice holders 34 or within a splice organizer as shown. Although not shown, a splice tray may be used to secure the optical fiber splices in a known manner.

The base 22 defines a funnel-shaped cable guiding feature 36 and a cable routing feature 38, with both features being operable for guiding and routing the distribution cable and drop cables around the periphery of the closure 20, while maintaining the minimum bend radius of the cable. Each feature 36, 38 comprises an L-shaped flange that captures and guides the cables. As shown, the flanges may be provided with stiffening ribs. A lip 48 of the cover 24 extends over the cable routing feature 38 when the cover is in the closed configuration. Lances (not shown) may be provided along the periphery of the base 22 for strain relieving the cables using cable ties, wraps or clamps. The features 36, 38 further provide stabilization of the cables during installation. The outer periphery of the base 22 curves inwardly on one end to form a cable entry location 40. A plurality of fingers or tabs 42 guide the cables into the cable seal area 44. In a preferred embodiment, the closure 20 is oriented with the major axis of the elliptical base 22 generally parallel to the aerial strand and hangs below the strand to prevent water from running along the cables into the closure 20. The cable seal area 44 comprises two sets of tooth-shaped cable retention clips 46 for retaining and aligning the cables. The size of the spaces provided on the retention clips 46 may be varied whether a distribution cable or a drop cable is routed through a particular slot. The cables may be snapped into the retention clips 46 and held in place during installation. The cable seal area 44 comprises a foam, gel, rubber or like sealing material positioned between the pair of retention clips 46 operable for providing a compression seal. The retention clips 46 align the cables at the cable seal area 44 and insure sufficient compression of the cable sealing material on each cable. The cable sealing material is retained within the closure 20 in the cable seal area 44 when the cover 24 is secured to the base 22 so that the cable sealing material compresses the cables as the cover 24 is closed.

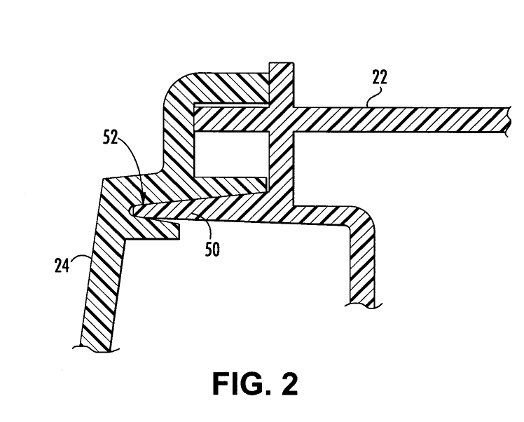

Referring now to FIG. 2, a cross sectional view of the sealing feature between the base 22 and the cover 24 is shown. The cover 24 and base 22 sealing feature comprises a double walled lip that prevents water intrusion, and in particular wind-driven rain, from entering the closure 20 around its periphery without the use of a conventional gasket or other deformable sealing material. A cone-shaped ledge 50 of the base 22 is received within a groove 52 defined by the cover 24. The base 22 and cover 24 are compressed together when the screws 28 are tightened to produce an interference fit that prevents water intrusion into the interior of the closure 20. In addition, a similar design may be used at the fastener recesses 26, thus providing an interference fit when the screws 28 are tightened. Elimination of a gasket or other deformable sealing material in the design of the sealing feature reduces the complexity and the cost of the closure 20.

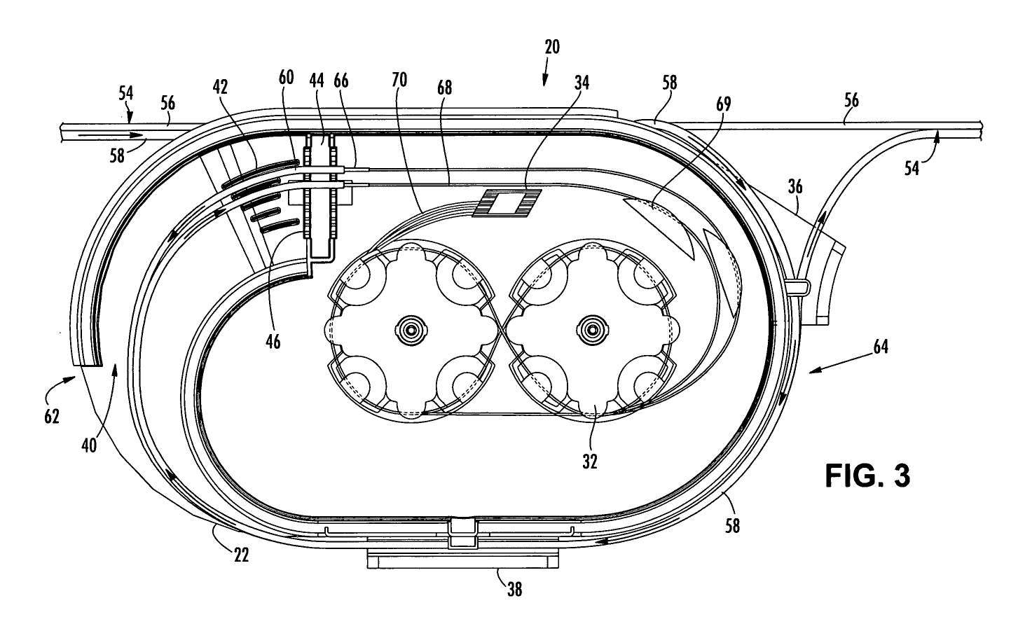

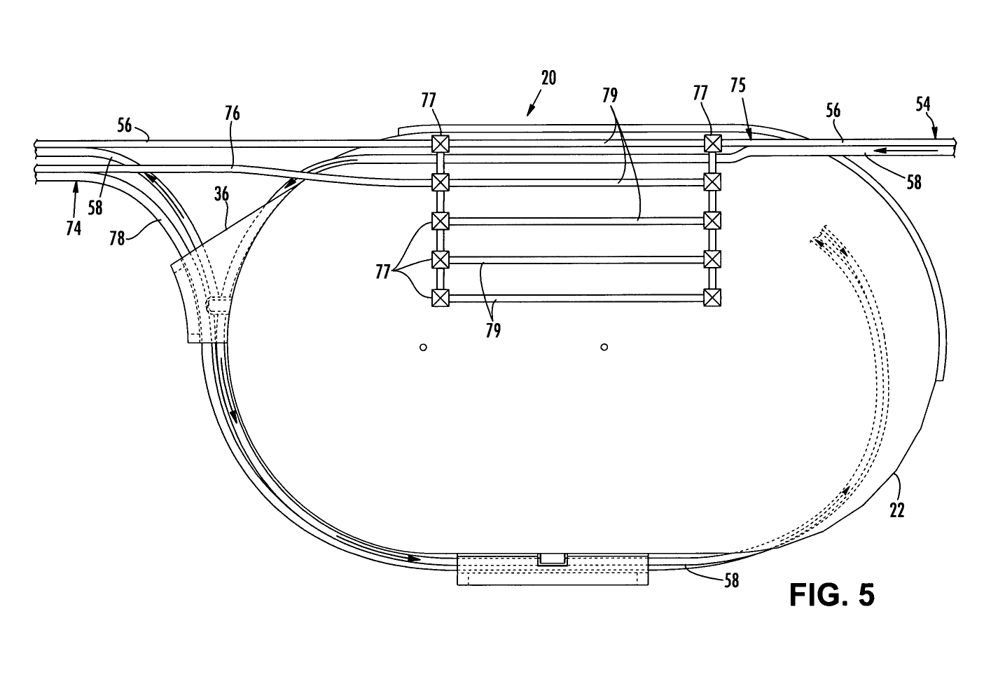

Referring to FIG. 3, one exemplary embodiment for routing a distribution cable 54 into and out of the interconnection closure 20 is shown. Although only one distribution cable 54 is shown, it is understood that more than one distribution cable may be routed throughout each closure 20, if practical. As shown and described in the exemplary embodiments provided herein, the distribution cable 54 is a figure-eight cable comprising a messenger component 56, including a conductive strength member, and an optical transmission component 58 with the messenger component 56 and the optical transmission component 58 separated by a cable jacket 60. In the exemplary embodiment shown, the upstream portion of the distribution cable 54 originates from the left-hand side 62 of the closure 20. The distribution cable 54 is routed behind the closure 20, and the messenger component 56 is severed and routed separate from the optical transmission component 58, as will be described in more detail below with reference to FIG. 5. The optical transmission component 58 of the distribution cable 54 is routed through the funnel-shaped cable guiding feature 36, around the outer periphery of the right-hand side 64 of the closure 20, through the cable routing feature 38 and into the cable entry location 40 that protects the interior of the closure 20 from water intrusion.

After entering the interior of the closure 20 through the cable seal area 44, the cable jacket 60 is preferably ring cut and removed from the portion of distribution cable 54 that is routed within the closure 20. The end of the cable jacket 60 adjacent the ring cut may be strain relieved in a known manner. The transport tube 66 is likewise ring cut and removed from the optical fibers 68 of the distribution cable 54 routed within the closure 20. The cable jacket 60 and the transport tube 66 may be simultaneously ring-cut and removed from the portion of the distribution cable 54 routed within the closure 20, as is well known in the art. The transport tube 66 may also be strain relieved in a known manner at or slightly beyond the cable seal area 44. The length of cable jacket 60 and transport tube 66 removed from the distribution cable 54 is preferably up to about 36 inches, more preferably up to about 24 inches. In alternative embodiments, the length of the cable jacket 60 and transport tube 66 that is removed may vary without departing from the scope of the invention. The locations of the ring cuts relative to the cable seal area 44 may also vary without departing from the scope of the invention. As shown, the incoming distribution cable 54 is routed into the cable seal area 44 adjacent the second tab 42 from the top, and the outgoing distribution cable 54 is routed out of the cable seal area 44 adjacent the top tab 42.

The optical fibers 68 of the distribution cable 54 are routed around fiber routing guides 69 to the first (right-hand as seen in FIG. 3) routing spool 32. However, in an alternative embodiment, the routing guides 69 may not be present and the optical fibers 68 are then routed directly to one of the routing spools 32. A predetermined amount of optical fiber slack is routed in a convenient figure-eight pattern around the routing spools 32 and into the splice holder 34 from the left-hand side. By having two routing spools 32, it is possible to wrap the optical fiber slack in either clockwise or counterclockwise directions around each spool 32 to obtain a desired entry orientation into the splice holder 34. A predetermined number of preselected optical fibers 70 are terminated and routed into the splice holder 34 for interconnection with optical fibers of one or more drop cables, as will be described. In all embodiments, the terminated optical fibers 70 of the distribution cable 54 are routed such that the ends of the optical fibers 70 enter the splice holder 34 opposite the ends of the optical fibers of the drop cables. The express (i.e., un-terminated) optical fibers 68 of the distribution cable 54 are routed around the routing spools 32 in a convenient figure-eight pattern and exit the closure 20 via the cable seal area 44. The cable jacket 60 and the transport tube 66 of the outgoing distribution cable 54 begin again prior to entering the cable seal area 44. The outgoing distribution cable 54 is next routed through its appropriate tab 42 and exits the closure 20 via the cable entry location 40. The distribution cable 54 is then routed around the outer periphery of the closure 20 through the cable routing feature 38 and the funnel-shaped cable guiding feature 36 in the downstream (i.e., subscriber) direction, where another preselected set 70 of optical fibers 68 of the distribution cable 54 may be terminated within another interconnection closure 20.

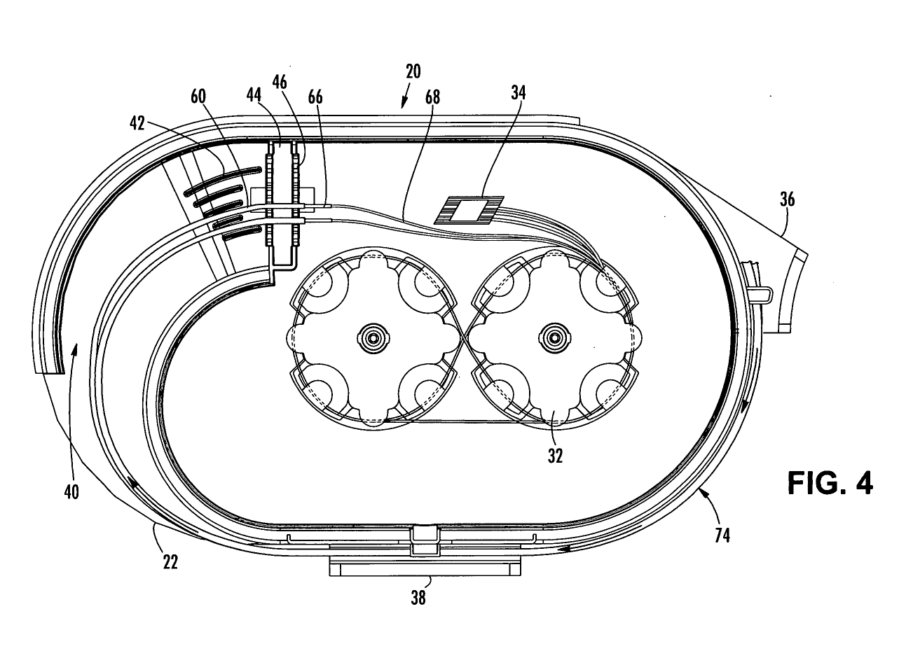

Referring to FIG. 4, one exemplary embodiment for routing one or more fiber optic drop cables 74 within and out of the interconnection closure 20 is shown. Although two drop cables 74 are shown, it is understood that one or more optical fibers 68 of one or more drop cables 74 may be interconnected with one or more of the terminated optical fibers 70 of the distribution cable 54 (FIG. 3) within the closure 20. The drop cables 74 include all types of optical fiber cables comprising a plurality of optical fibers within a cable jacket including, but not limited to, loose tube, monotube, central tube, tight buffered, ribbon, flat dielectric, figure-eight and the like. In the exemplary embodiments shown and described herein, each figure-eight drop cable 74 comprises a messenger component 76, including a conductive strength member, an optical transmission component 78 and a cable jacket 60, wherein the optical transmission component and the messenger component are separated from each other via the cable jacket 60 resulting in a cross section having a figure-eight configuration. The plurality of drop cables 74 enter the closure 20 through the cable entry location 40. The drop cables 74 are routed around the outer periphery of the closure 20 and conform closely to the contour of the closure 20. The cable routing feature 38 maintains the drop cables 74 along the lower edge of the closure 20. In the routing embodiment shown, the drop cables 74 are routed away from the closure 20 through the funnel-shaped cable guiding feature 36, where they may be lashed to the aerial strand and continue either in the downstream or upstream direction. In an alternative embodiment, the drop cables 74 are routed directly to a subscriber premises or network connection terminal and are not routed through the funnel-shaped feature 36. Although not shown in FIG. 4, the drop cables 74 may be strain relieved to the closure in a known manner. Alternatively, the messenger component 76 of the drop cables 74 may be strain relieved to the back side of the base 22 as shown in FIG. 5.

As with the distribution cable 54 described above, after passing through the cable seal area 44, the cable jackets 60 and the transport tubes 66 of the drop cables 74 are preferably ring cut, terminated and strain relieved in a known manner. The length of cable jacket 60 and transport tube 66 removed from the drop cables 74 is preferably up to about 36 inches, more preferably up to about 24 inches. In alternative embodiments, the length of the cable jacket and transport tube removed and the points of removal may vary without departing from the scope of the invention. As shown, the drop cables 74 entering the closure 20 are routed into the cable seal area 44 adjacent the lower tabs 42.

A predetermined amount of slack optical fibers 68 of the drop cables 74 is routed in a convenient figure-eight pattern around the two routing spools 32 and into the right-hand side of the splice holder 34. By having two routing spools 32, it is possible to wrap the slack optical fiber in either clockwise or counterclockwise directions around each routing spool 32 to obtain a desired entry orientation into the splice holder 34 and to store a desired amount of slack. A predetermined number, and typically all, of the optical fibers 68 of the drop cables 74 are routed into the splice holder 34. In the preferred embodiment, the optical fibers 68 of the drop cables 74 are routed such that the ends of the optical fibers 68 enter the splice holder 34 opposite the ends of the optical fibers 70 of the distribution cable 54 terminated within the closure 20.

Referring to FIG. 5, a bottom plan view of the interconnection closure 20 illustrates an exemplary routing of the distribution cable 54 and its respective messenger component 56 and optical transmission component 58, and the routing of a typical drop cable 74 and its respective messenger component 76 and optical transmission component 78, on the back side of the closure 20. As indicated by reference numeral 75, the messenger component 56 of the distribution cable 54 is shown cut and separated from the optical transmission component 58 that is routed around and within the closure 20. The conductive strength member of the messenger component 56 is then routed and secured to a conductive grounding strip 79 using grounding screws or clamps 77. The messenger component 56 is also separated from the optical transmission component 58 downstream and a length of the messenger component 56 is removed completely. The length of messenger component 56 removed is roughly equivalent to the amount of optical transmission component 58 routed around and within the closure 20, less a short section of about a few inches that corresponds to the distance between the grounding clamps 77. The grounding strip 79 is a conductive bracket operable to provide strain relief and maintain conductivity along the conductive strength member of the distribution cable 54. The messenger component 76 of the drop cable 74 exiting the closure 20 is separated and the conductive strength member is routed to a grounding clamp 77 on one side of the grounding strip 79. The strength member of each messenger component 76 of each drop cable 74 may be routed to a separate clamp 77 of the grounding strip 79, or the strength members may be ganged at one or more clamps 77 in a known manner.

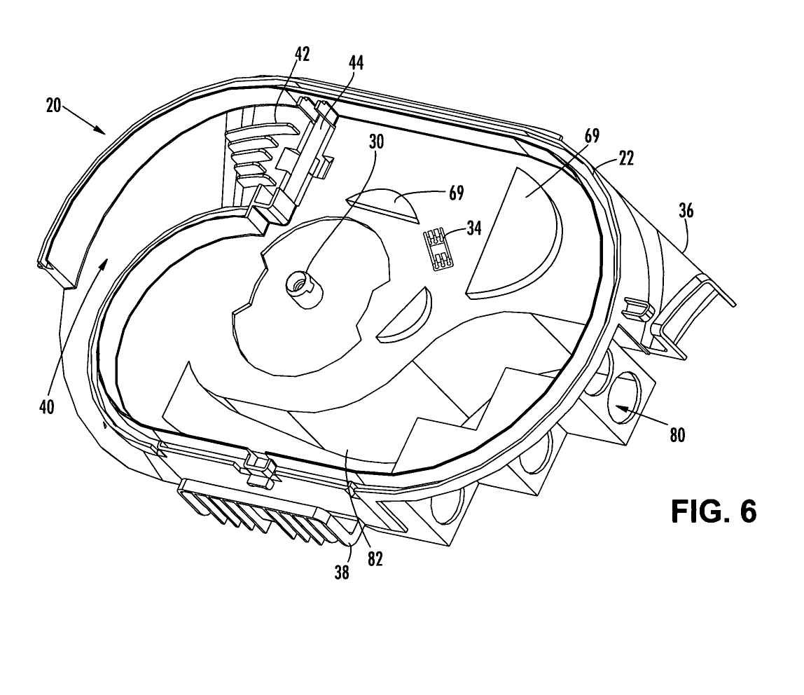

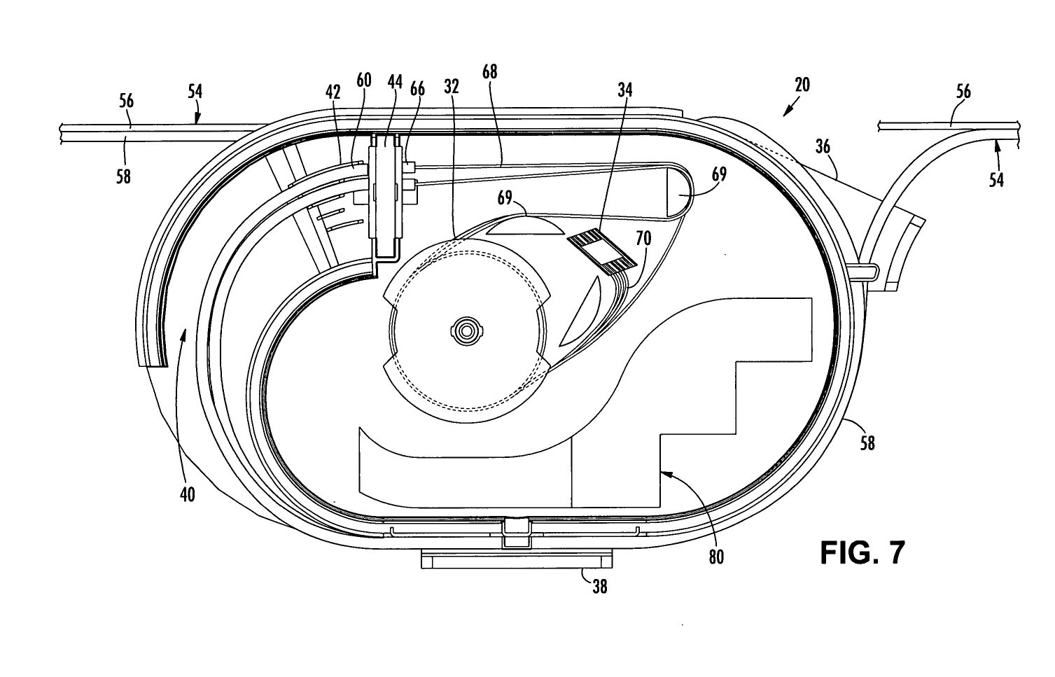

Referring to FIG. 6, an alternative embodiment of an interconnection closure 20 shown with the cover removed and having a cable entry location 40, a post 30 for receiving a fiber routing spool 32 (FIG. 7) and a plurality of connector ports 80 is shown. In contrast to the previous embodiment, one or more drop cables 74 may be interconnected with terminated optical fibers 70 of the distribution cable 54 via one or more connector ports 80 that open through at least one exterior wall of the closure 20. Although the closure 20 is shown having six connector ports 80 arranged in adjacent pairs opening through a side portion of the base 22, it is envisioned that any number of connector ports 80 may open through any portion of the base 22 in any desired configuration. The connector ports 80 are shown unoccupied, but are preferably occupied with receptacles adapted to receive a connectorized drop cable from the outside of the closure 20 and a length of connectorized optical fiber (i.e., “a pigtail”) from the inside of the closure 20. Unoccupied connector ports 80 comprising receptacles may be covered with a protective dust cap or plug until needed. A routing surface 82 formed in the base 22 is provided for guiding the pigtails from within the closure 20 to their respective connector ports 80 while maintaining a minimum bend radius. In the exemplary embodiment provided herein, a single routing spool 32 is shown to limit the overall size of the closure 20. However, the closure 20 may be slightly enlarged in order to accommodate two routing spools 32 and figure-eight routing of the optical fibers of the distribution cable, as previously described.

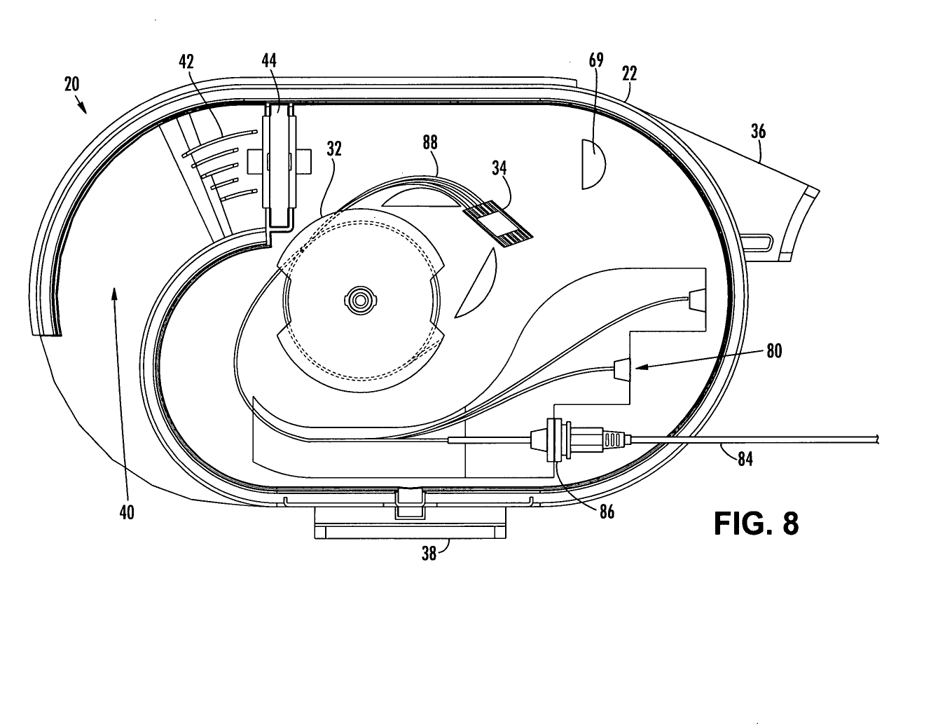

The closure 20 is shown in FIGS. 6-8 with fiber routing guides 69 secured within the interior of the closure 20 to the back wall of the base 22. The fiber routing guides 69 are operable for maintaining a minimum bend radius, preferably greater than about 1.5 inches, of the optical fibers or pigtails entering and exiting the splice holder 34. As shown, the fiber routing guides 69 have a “half-moon” shape and may define grooves or channels on their outer surfaces for guiding and retaining the optical fibers or pigtails. As shown in FIG. 8, a connectorized drop cable 84 may be connected to the exterior side of the connector port 80. The connector port 80 provides an adequately strong anchoring point for supporting any tensile load applied to the drop cable 84. The force applied to the connector port 80 from the drop cable 84 is transferred from the connector port 80 to the base 22 of the closure 20, which is secured to a distribution cable 54 having a messenger component 56, or to an aerial strand. Thus the force from the drop cable 84 is not transferred to the pigtail or the terminated optical fiber of the distribution cable within the closure 20.

Referring to FIG. 7, one exemplary embodiment for routing a distribution cable 54 into, within and out of the interconnection closure 20 is shown. Although only one distribution cable 54 is shown, it is understood that more than one distribution cable may be routed into, within and out of the closure 20. As shown, the distribution cable 54 is a figure-eight cable comprising a messenger component 56, including a conductive strength member, and an optical transmission component 58 separated by a cable jacket 60. In the exemplary embodiment shown, the upstream portion of the distribution cable 54 originates from the left-hand side of the closure 20. The distribution cable 54 is routed behind the closure 22, and the messenger component 56 is severed and routed separate from the optical transmission component 58, as shown and described with reference to FIG. 5. The optical transmission component 58 of the distribution cable 54 is routed through the funnel-shaped cable guiding feature 36, around the outer periphery along the right-hand side of the closure 20, through the cable routing feature 38 and into the cable entry location 40 that is protected from water intrusion.

As with the previous embodiment, after entering the closure 20 through the cable seal area 44, the cable jacket 60 and the transport tube 66 are ring cut and removed from the portion of distribution cable 54 routed within the closure 20. The cable jacket 60 and the transport tube 66 may be strain relieved adjacent the ring cut in any known manner at or beyond the cable seal area 44. The length of cable jacket 60 and transport tube 66 removed from the distribution cable is preferably up to about 36 inches, more preferably up to about 24 inches. In alternative embodiments, the length of the cable jacket 60 and transport tube 66 removed may vary without departing from the scope of the invention. The locations of the ring cuts relative to the cable seal area 44 may also vary without departing from the scope of the invention. As shown, the incoming distribution cable 54 is routed into the cable seal area 44 adjacent the second tab 42 from the top, and the outgoing distribution cable 54 is routed out of the cable seal area 44 adjacent the top tab 42.

The optical fibers 68 of the distribution cable 54 are routed around fiber routing guides 69 and onto the routing spool 32. However, in an alternative embodiment, the fiber routing guides 69 may not be present and the optical fibers 68 may be routed directly to the routing spool 32. A predetermined amount of slack optical fiber 68 is routed around the routing spool 32 in a preferred direction and into the splice holder 34. As previously described, a predetermined number of the optical fibers 70 are terminated and routed into the splice holder 34. Preferably, the ends of the terminated optical fibers 70 of the distribution cable 54 are routed such that they enter the splice holder 34 opposite the ends of the pigtails. The express (i.e., un-terminated) optical fibers 68 of the distribution cable 54 are routed around the routing spool 32 and if desired around the fiber routing guides 69 to exit the closure 20 via the cable seal area 44. The cable jacket 60 and the transport tube 66 of the outgoing distribution cable 54 begin again prior to entering the cable seal area 44 from the interior of the closure 20. The outgoing distribution cable 54 is routed through its appropriate tab 42 and exits the closure 20 via the cable entry location 40. The distribution cable 54 is then routed around the periphery of the closure 20 through the cable routing feature 38 and the funnel-shaped cable guiding feature 36 in the downstream (i.e., subscriber) direction, where another preselected set 70 of optical fibers 68 of the distribution cable 54 may be terminated within another interconnection closure 20.

Referring to FIG. 8, one exemplary embodiment for routing a plurality of fiber optic drop cables 84 and connectorized pigtails 88 is shown. Although only a typical drop cable 84 is shown connected to a connector port 80, it is understood that one or more optical fibers of one or more drop cables 84 may be interconnected with one or more terminated optical fibers 70 of the distribution cable 54 via the plurality of connector ports 80. The drop cable 84 includes any type of connectorized optical fiber cable comprising one or more optical fibers disposed within a cable jacket including, but not limited to, loose tube, monotube, central tube, tight buffered, ribbon, flat dielectric, figure-eight and the like. The connector of the drop cable 84 includes, but is not limited to, SC, LC, FC, MPO, MT-RJ and similar connector types. The plurality of connectorized pigtails 88 are spliced at their un-connectorized ends to the terminated optical fibers 70 of the distribution cable 54. The pigtails 88 are then routed around the routing spool 32 in a convenient direction to manage and store lengths of slack before being routed to the respective connector ports 80. The connectorized ends of the pigtails 88 are connected to the receptacles 86 disposed within the connector ports 80. The pigtail length is preferably from about 12 to about 36 inches in length, thus providing sufficient slack lengths for re-splicing should the need arise. Although not shown in FIG. 8, the drop cables 84 may be strain relieved to the closure 20 in any known manner. Alternatively, figure-eight style drop cables 84 may be strain relieved to the base 22 of the closure 20 in the manner shown and described with reference to FIG. 5.

The foregoing is a description of various embodiments of the invention that are given here by way of example only. Although fiber optic interconnection closures with integral cable management and sealing features have been described with reference to preferred embodiments and examples thereof, other embodiments and examples may perform similar functions and/or achieve similar results. All such equivalent embodiments and examples are within the spirit and scope of the present invention and are intended to be covered by the claims appended hereto.

1. A fiber optic interconnection closure, comprising:
a base; and
a cover adapted to be secured to the base;
wherein an outer periphery of the base defines a surface for routing a fiber optic distribution cable into a cable entry location defined by the base.

2. The fiber optic interconnection closure of claim 1, further comprising a funnel-shaped cable guiding feature on an external wall of the closure operable for guiding the distribution cable along the outer periphery of the base and away from the interconnection closure.

3. The fiber optic interconnection closure of claim 1, further comprising a splice holder within the interior of the closure operable for receiving one or more splice holders.

4. The fiber optic interconnection closure of claim 1, further comprising one or more fiber routing spools operable for managing a slack length of optical fiber of the distribution cable within the closure.

5. The fiber optic interconnection closure of claim 1, further comprising one or more cable retention clips adjacent the cable entry location for maintaining and aligning the fiber optic distribution cable through a cable seal area.

6. The fiber optic interconnection closure of claim 1, wherein the base further comprises a cable seal area disposed within the cable entry location that is shielded from water intruding into the closure along the distribution cable and from wind-driven rain by the contour of the outer periphery of the base.

7. The fiber optic interconnection closure of claim 1, wherein the cover defines a lip operable for maintaining the distribution cable within a cable routing feature defined by the outer surface of the base of the closure.

8. The fiber optic interconnection closure of claim 1, wherein a sealing feature between the cover and the base comprises a gasket-less, double walled lip that prevents water intrusion into the closure from around the outer periphery of the base.

9. The fiber optic interconnection closure of claim 1, further comprising a plurality of tabs disposed within the cable entry location for guiding the distribution cable into the closure.

10. The fiber optic interconnection closure of claim 1, wherein the distribution cable is a figure-eight cable comprising a messenger component including a conductive strength member, an optical transmission component and a cable jacket separating the messenger component and the optical transmission component.

11. The fiber optic interconnection closure of claim 10, further comprising a grounding strip on the back side of the base for strain relieving and grounding the conductive strength member of the messenger component.

12. The fiber optic interconnection closure of claim 1, further comprising at least one connector port located within an exterior wall of the base operable for receiving at least one connectorized fiber optic drop cable from the outside of the closure.

13. A fiber optic interconnection closure, comprising:
a base;
a cover adapted to be secured to the base; and
at least one connector port located in an exterior wall of the base;
wherein an outer periphery of the base defines a surface for routing a fiber optic distribution cable into a cable entry location defined by the base.

14. The fiber optic interconnection closure of claim 13, further comprising a funnel-shaped cable guiding feature on an external wall of the closure operable for guiding the distribution cable along the outer periphery of the base and away from the interconnection closure.

15. The fiber optic interconnection closure of claim 13, further comprising one or more fiber routing spools operable for managing a slack length of optical fiber of the distribution cable within the closure.

16. The fiber optic interconnection closure of claim 13, wherein the base further comprises a cable seal area disposed within the cable entry location that is shielded from water intruding into the closure along the distribution cable and from wind-driven rain by the contour of the outer periphery of the base.

17. The fiber optic interconnection closure of claim 13, wherein a sealing feature between the cover and the base comprises a gasket-less, double walled lip that prevents water intrusion into the closure from around the outer periphery of the base.

18. The fiber optic interconnection closure of claim 13, wherein the distribution cable is a figure-eight cable comprising a messenger component including a conductive strength member, an optical transmission component and a cable jacket separating the messenger component and the optical transmission component and wherein the closure further comprises a grounding strip on the back side of the base for strain relieving and grounding the strength member of the messenger component.

19. The fiber optic interconnection closure of claim 13, further comprising a receptacle disposed within the at least connector port adapted to receive a connectorized optical fiber from the inside of the closure and a connectorized drop cable from the outside of the closure.

20. A fiber optic communications network, comprising:
a fiber optic distribution cable comprising a plurality of optical fibers and at least one mid-span access location along the length of the distribution cable for accessing and terminating preselected ones of the plurality of optical fibers;
at least one fiber optic drop cable comprising at least one optical fiber optically connected to at least one of the preselected optical fibers of the distribution cable; and
an interconnection closure comprising a base and a cover, wherein an outer periphery of the base defines a surface for routing the fiber optic distribution cable into a cable entry location defined by the base.
